(19) United States
(12) Patent Application Publication
(10) Pub. No.: US 2015/0339747 A1
(43) Pub. Date: Nov. 26, 2015

(54) Commercializing Manufacturer-Direct Products Under a Common Brand

(71) Applicant: Factoryzoom International Inc., Grand Cayman (KY)

(72) Inventor: Jason Chen, Palo Alto, CA (US)

(21) Appl. No.: 14/284,321

(22) Filed: May 21, 2014

(51) Int. Cl. G06Q 30/06; G06Q 10/08; G06Q 30/02

(52) U.S. Cl. CPC G06Q 30/0617; G06Q 30/0241; G06Q 30/0635; G06Q 10/0836; G06Q 10/0831

(57) ABSTRACT

An intermediary company markets products under its own brand name, but where the orders are between customers and the manufacturers, rather than with the intermediary company. In one implementation, the intermediary company operates primarily online. Its web site or other online presence is used to advertise the products and to take orders, and possibly also payment. The intermediary company authorizes third party operators to operate physical showrooms to display sample products. In return for their investment in the showrooms, the operators receive some commission on relevant sales. Since orders are primarily placed online, each operator's “territory” may include an online region.

### BACKGROUND OF THE INVENTION

1. Field of the Invention

This invention relates generally to aggregating different manufacturer products under a common brand and commercializing them directly to the customer.

2. Description of the Related Art

Many manufacturers may produce good products but do not have the expertise to distribute the products to the marketplace. For example, manufacturers may not understand what products or which versions of products and features are desired by customers, they may not understand how to effectively market and advertise their products to customers, they may not have the financing and/or supply chain expertise to sell and physically deliver products to customers, and they may not have enough physical presence to effectively commercialize their products.

This is especially true if the customers are located in a different environment than the manufacturer, for example U.S. consumers buying products from Chinese manufacturers. A Chinese manufacturer may not fully appreciate the desires of U.S. customers. The cross-border nature of these transactions further complicates matters. For example, customs, duties and letters of credit between U.S. and Chinese entities add additional layers of complexity.

Large manufacturers may have enough economy of scale to build up expertise for themselves. However, many manufacturers are not large enough to make this a cost-effective solution.

Another traditional approach is the use of middlemen, such as distributors. A local U.S. distributor may better understand the local U.S. market, purchase products that are appropriate for the market, and then resell these products to U.S. customers. However, this requires a significant investment and capital resources from the distributor. The distributor purchases and pays for units of the manufacturer's products, keeps them in inventory on the distributor's account since they now belong to the distributor, and then resells them to its customers. The distributor must have sufficient capital to stock sufficient inventory. It also takes the risk if customers do not buy the inventory.

In yet another approach, a retailer may purchase products from many different manufacturers to be sold under the retailer's brand. Examples include Pottery Barn and Williams and Sonoma. However, this requires operating a full retail operation, typically with significant physical presence, large physical distribution and significant advertising and marketing. The retailer makes a significant investment to develop all of these aspects of its business.

As another alternative, some e-commerce sites such as eBay or Amazon act as a virtual marketplace. Manufacturers may offer their products to customers. However, these sites are typically just a platform and provide little, if any, significant additional services to the manufacturer.

Thus, there is a need for better approaches for manufacturers to sell direct to customers, especially in cases where the manufacturers may not have a good understanding of the relevant market.

### SUMMARY

The present invention overcomes the limitations of the prior art by providing an intermediary company that markets products under its own brand name, but where the orders are between customers and the manufacturers rather than with the intermediary company.

In one aspect, the intermediary company qualifies manufacturers and obtains commitments to allow the intermediary company to advertise products from the manufacturers under the intermediary company's brand name. The intermediary company receives orders and payment for its branded products from customers. The intermediary company retains a commission on the payments, and transmits a portion of the payments to the manufacturers (including payment of the manufacturer's price for the product). Advantages of this approach are that the customer and manufacturer receive close to factory-direct pricing, and the intermediary company can build its own brand with significantly less capital.

In another aspect, the intermediary company operates primarily online. Its web site or other online presence is used to advertise the products and to take orders, and possibly also payment. An online implementation can allow those involved to more rapidly track activities: order activity, payments, delivery, inventory levels, etc.

One disadvantage of a purely online operation is that customers cannot easily inspect physical samples before ordering. One way to address this is by using physical showrooms. These showrooms display sample products for customers to inspect. However, it is expensive to own and operate a large number of physical showrooms. Therefore, in one approach, the intermediary company does not itself operate the showrooms. Rather, it authorizes third party operators to operate the showrooms. In return for their investment in the showrooms, the operators receive some commission on relevant sales. Since orders are primarily placed online, each operator's “territory” may include an online “region.”

The approaches described above are especially suited for situations where the manufacturers and customers are separated (e.g., Chinese manufacturers and U.S. customers), the manufacturers are not large enough to market directly to the customers, and the intermediary company desires to grow quickly but without a very large capital investment.

Other aspects of the invention include methods, devices, systems, components, improvements and other technology related to the concepts described above.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a block diagram illustrating aspects of the present invention.

FIG. 2 is a flow diagram illustrating operation of an intermediary company.

FIG. 3 is a block diagram illustrating the use of representative physical showrooms.

FIG. 4 is a block diagram illustrating a payment model.

FIG. 5 is a block diagram illustrating various aspects of delivery of products to the customer.

FIG. 6 is a block diagram of a software system suitable for use with the invention.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

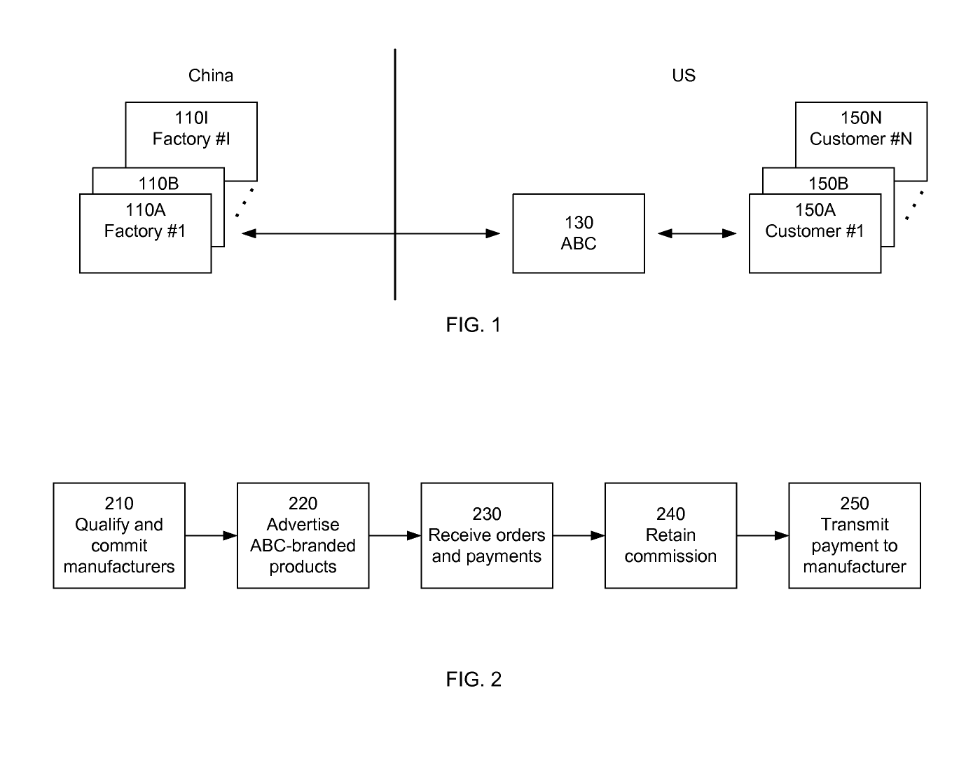

FIG. 1 is a block diagram illustrating aspects of the present invention. This example uses Chinese factories 110A-I, which produce products sold to U.S. customers 150A-N. For the manufacturers 110, a channel that is direct to the customers may be desirable because it may permit the manufacturer to charge more. For the customers 150, a factory-direct channel may also be desirable because it may permit the customer to pay lower prices. Overall savings can be realized by cutting out unnecessary intermediaries.

However, there are also drawbacks in a factory direct approach. The manufacturers may not have the expertise or infrastructure to deal directly with customers. For example, they may not understand what products would do well in the market, and they also may not have infrastructure to market, distribute and service their products. Analogously, customers also may not be well-equipped to deal directly with manufacturers. They may not be able to evaluate the quality and reputation of different factories, and they may not understand the requirements and limitations of factories.

Therefore, in FIG. 1, there is an intermediary company 130, which shall be referred to as the ABC Co. for convenience. ABC bridges the gap between factories 110 and customers 150, but does so in a non-traditional way. It offers manufacturer-direct products to customers through the ABC web site (or other online presence) under the ABC brand.

FIG. 2 is a flow diagram illustrating operation of the intermediary company ABC. ABC builds its own brand of products. It sets up relationships 210 with multiple manufacturers to supply products that will be sold under the ABC brand through ABC's online presence. ABC may work with a large number of different manufacturers, for example at least 100, at least 500 or at least 1000 different manufacturers. The number of manufacturers will depend in part on the breadth of ABC's product offering. ABC may also work with several manufacturers per product in order to have multiple sources of products.

Since it is building a brand, ABC typically will exert control over its product offerings. In addition to obtaining commitments from manufacturers to provide products to be ABC-branded, ABC typically may also qualify the manufacturers before accepting their products. For example, ABC may visit and review the factory in order to qualify it before offering its products. ABC may also consider and/or control various quality or reputation aspects of the manufacturer or its products.

ABC typically will also select which products will be offered (i.e., the overall product mix), since they are being offered under the ABC brand. For example, ABC may limit its product mix to certain product categories: home improvement (e.g., home construction and home remodeling); home, garden and tools; beauty, health and cosmetics; shoes and clothing; jewelry; toys and games; sports and outdoors; children's; automotive; industrial; computers and electronics; etc.

Some or all of the products may even be designed or specified by ABC. For example, if ABC has a better understanding of the end customer, it may request custom products from the manufacturer. Product selection (including quality and price considerations) is one aspect to overall branding. This is different from marketplace web sites that merely supply an Internet platform where nearly any merchant can set up an online storefront. In these marketplace web sites, each merchant makes its own product selection which it sells under its own brand. The marketplace operator does not try to build a cohesive brand from among all the participating merchants. In contrast, in FIGS. 1 and 2, ABC typically is selecting the product mix, and the products are advertised under the ABC brand.

The advertising 220 may take traditional forms, such as online ads, print ads and various promotions. In one approach, the advertising 220 takes advantage of physical showrooms operated by other entities. For convenience, these will be referred to as representative physical showrooms. They are “representative” in the sense that they represent ABC, but are not owned by ABC. They are “physical,” as opposed to online or virtual. These representative physical showrooms will be described in more detail below.

Customers place orders for products and make payments. ABC receives 230 the customer orders and the payments. ABC retains 240 a commission for the order and transmits 250 a portion of the payment to the manufacturer. For convenience, this portion shall be referred to as the manufacturer's invoice amount. It includes the amount that the manufacturer receives for the product itself, which will be referred to as the base price for the product. The manufacturer's invoice amount may also include ancillary costs, such as packing, shipping, taxes, duties, insurance, etc. ABC's commission may be based on the base price for the product, the manufacturer's invoice amount, or the payment received from the customer. Because there are no markups for any additional intermediaries between the manufacturer and ABC, the price to the customer is close to the base price so that the customer receives pricing that is close to factory direct. In one business model, the manufacturer is responsible for delivering the product to the customer, although ABC may help in overall management of the supply chain to the customer (as will be described in more detail below).

Note that this situation is different from a typical factory-direct situation, because the factory does not directly collect the order or the payment from the customer. Rather, the intermediary company ABC collects the order and the payment from the customer. In addition, the products are branded under the ABC brand and not under the manufacturer's brand. However, it is also different from a typical distributor situation, in that ABC does not first buy products from the manufacturer and then resell to the customer. Rather, the products are the manufacturer's products until ABC secures an order. ABC collects payment from the customer and can pay the manufacturer from the customer's payment. ABC is not required to borrow money in order to first buy a large volume of inventory from the manufacturer. In one model, ABC takes the products on consignment from the manufacturer and sells to the customer in that way. In another model, ABC purchases the products from the manufacturer but does not make payment to the manufacturer until after ABC receives payment from the customer. Either approach reduces ABC's cash requirement.

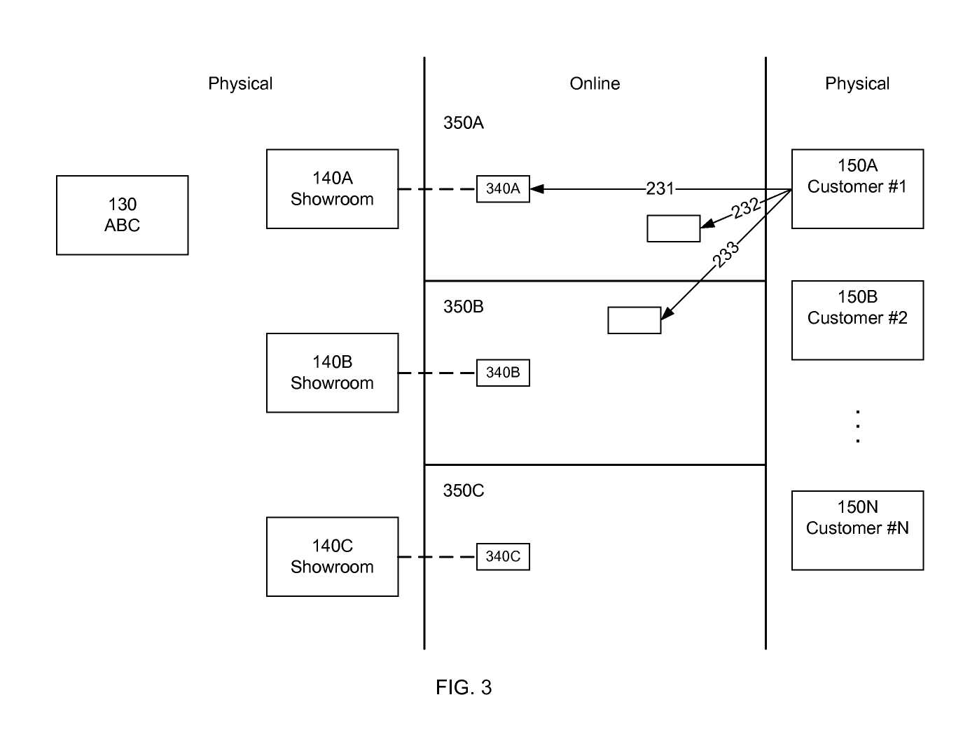

One advantage of selling solely (or primarily) online is that it reduces the expense for physical locations. One drawback to selling solely (or primarily) online is that customers have limited opportunity to examine the products before purchasing. FIG. 3 is a block diagram illustrating the use of representative physical showrooms to address this issue. This diagram shows several representative physical showrooms 140A-C. These are physical locations that customers can visit. They carry sample products for display purposes, so that customers can examine products before purchasing. However, these physical showrooms are not owned and operated by ABC.

Rather, they are owned and operated by other entities, under authorization from ABC. In this way, ABC avoids the expense of building out and operating a large number of physical showrooms. It is somewhat a franchise model. ABC typically will have some control over the representative physical showrooms. For example, just as with manufacturers and products, there may be a qualification process to become a showroom. ABC may also control or provide guidelines for look, presentation, color scheme, product placement, product mix, promotions, seasonal changes and other aspects and branding of the showroom.

The showroom operators make the investment in the physical showrooms, so they expect to earn a return on the investment. In most franchise models, the franchisee recoups his investment by purchasing products and reselling them at a higher price. However, in this case, ABC does not purchase products from the manufacturer and resell them. The customer buys direct from the manufacturer, in part to reduce the capital requirements on ABC.

A similar situation applies to the showrooms. In one business model, the representative physical showrooms function purely as showrooms and do not carry inventory for retail sale to customers. Rather, if a customer is interested to buy, he places the order through ABC's online presence. The showroom operator receives a commission for those orders placed from an online “region” that has been assigned to that showroom. The online region preferably corresponds to a physical location of the showroom.

Referring to FIG. 3, the middle section of the figure represents the online universe, which is divided into three regions 350A-C. Online region 350A has been assigned to representative physical showroom 140A, region 350B assigned to showroom 140B and region 350C assigned to showroom 140C. Object 340A is the online location corresponding to physical showroom 140A, and so on. For example, an order placed at the ABC web site from a computer located in the physical showroom 140A would be coming from online location 140A. The online regions may be defined in various ways, using common techniques associating online characteristics (e.g., online addresses) with physical locations.

The operator of showroom 140A receives a commission on all orders placed from online region 350A, regardless of whether placed from the showroom 140A or whether the customer even visited the showroom 140A. The incentives may be structured so that the operator receives a higher commission if the showroom 140A was somehow involved, for example if the order was placed from the showroom 340A or if the customer types in a special code received upon visiting the showroom 140A. In this way, the showroom operators are incentivized to make investments to build ABC brand awareness.

In this example, customer 150A visits showroom 140A and places an order 231 at the ABC web site from the showroom location 340A. Operator 140A receives a commission on this order. The customer 150A later returns home and places a second order 232 from a location that is within operator 140A's online region 350A. Operator 140A also receives a commission on this order. A year later, customer 150A places another order 233 from online region 350B. Operator 140B receives this commission.

The description of FIG. 3 considered a purely online order and sales model, with no physical retail sales. That is, all orders are placed online and all showrooms function solely for display of products and not for retail sale. This was done for illustrative purposes and is not required, although there are advantages to this approach, as described above. More mixed approaches are also possible. For example, some or all of the showrooms may carry limited inventory and may make limited retail sales. As another example, perhaps not all orders are placed online through the ABC web site. Orders could be placed at showrooms using other media, such as a salesperson manually taking an order from a customer.

Since the showrooms are physical, they could also play other roles. For example, products could be shipped to the showrooms for pick up by customers. The showrooms could also accept returns, and provide training, service and/or support. This could be useful if ABC is responsible for these product-related services, since ABC itself is structured to reduce the physical locations that it owns or operates.

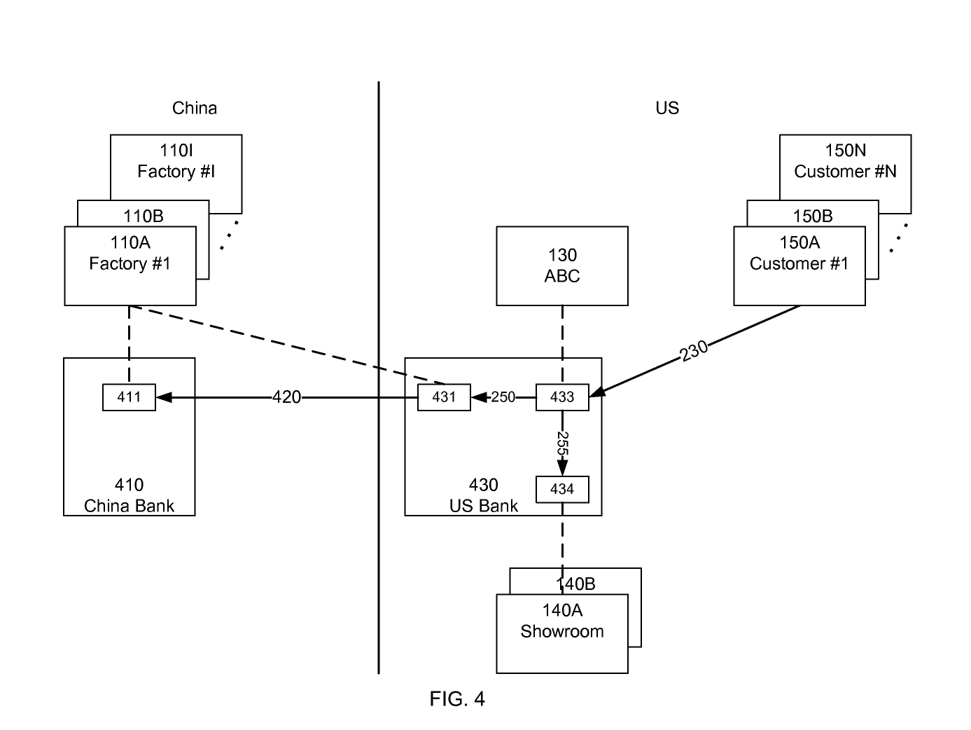

FIG. 4 is a block diagram illustrating a payment model. If ABC were a traditional distributor, it would purchase products from the manufacturer, either with funds transfer or a letter of credit. Funds transfer requires a significant amount of capital. Letter of credit adds complexity for cross-border transactions.

In FIG. 4, most of the transactions occur at bank 430, which is a local bank for ABC. ABC keeps an account 433 at bank 430, as do the manufacturer 110A (account 431) and the operator of representative physical showroom 140A (account 434). The customer makes payment 230 to ABC's account 433. ABC retains a commission on the payment. ABC transmits 250 the manufacturer's invoice amount to the manufacturer's account 431. ABC also transmits 255 a commission to the showroom operator's account 434, if applicable. The manufacturer may check its account balance and, from time to time, may transfer 420 funds to the manufacturer's account 411 at bank 410, which is local for the manufacturer.

Having all accounts at U.S. bank 430 is advantageous because it simplifies the transfer of funds between ABC and the other entities. However, this is not required. Much of this can be accomplished between accounts at different banks, especially if it is fairly straightforward to transfer funds between the banks. In an alternate implementation, the funds are not dispersed to different bank accounts. Rather, the funds all stay in ABC's account, but ABC makes an internal accounting as to how much of these funds belong to the manufacturer, to the showroom operator, etc. Hybrid approaches are also possible. For example, some entities may have separate bank accounts while others rely on ABC's internal accounting. Or ABC may use an internal accounting and periodically transfer funds to other entities' external accounts if balances exceed a certain amount, for example.

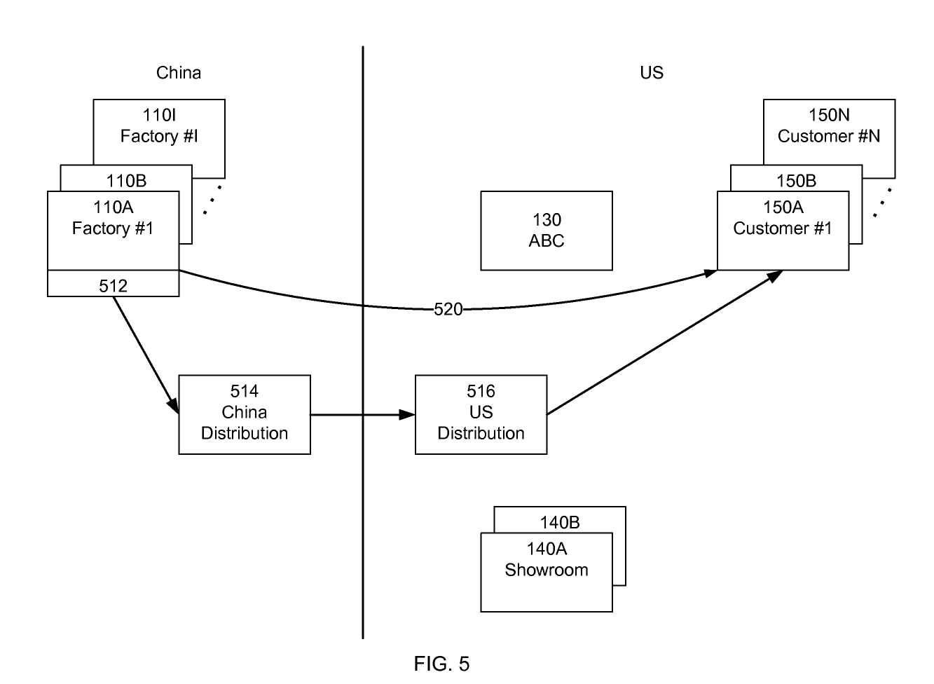

FIG. 5 is a block diagram illustrating various aspects of delivery of products to the customer. Because the customer order is with the manufacturer, the manufacturer is responsible for delivery of product to the customer. There will be a supply chain from the manufacturer's factory 110 to the customer 150. In the example of FIG. 5, the supply chain includes a warehouse 512 at the factory 110, China distribution center 514 and U.S. distribution center 516. The distribution centers may be operated by the manufacturer or by ABC. For example, a manufacturer-operated China distribution center 514 may handle distribution of the manufacturer's products, both the ABC-branded products and other products. An ABC-operated China distribution center 514 may handle distribution of ABC-branded products for many manufacturers. Note that in this case, ABC operates the distribution center 514 and may coordinate among different manufacturers, but ABC does not own the products. The products in the supply chain are owned by the manufacturer since ABC does not buy the products from the manufacturer.

Similarly, the US distribution center 516 may be manufacturer-operated to handle distribution of the manufacturer's products in the U.S. More likely, the US distribution center 516 will be ABC operated, since ABC may have more economies of scale over many manufacturers supplying products.

Transport between warehouses can also be arranged by the manufacturer or by ABC. Products are typically transported by container ship between China and the U.S. The manufacturer may be able to aggregate over ABC-branded products and other products to fill a container. Alternately, ABC may be able to aggregate over many manufacturers to fill a container.

Actual delivery can occur via the supply chain shown: from factory 110 to factory warehouse 512, to China distribution center 514, to U.S. distribution center 516 to the customer 150, as shown by the straight arrows. It could also occur via other routes. For example, large orders may be shipped direct 520 from the factory 110 to the customer 150, as shown by the curved arrow.

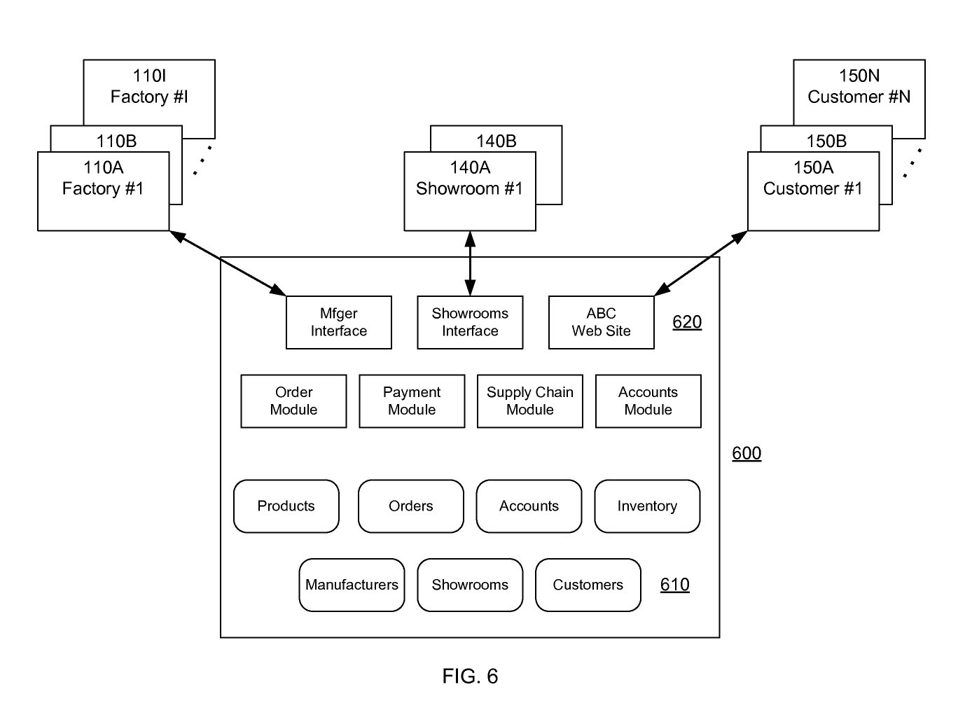

FIG. 6 is a block diagram of a software system 600 suitable for implementing the approaches described above. This software system implements the functions described above and provides better overall transparency to the various entities: ABC, customers 150, manufacturers 110 and showroom operators 140. The software system is operated by ABC. It includes various data records 610 (denoted by the rounded rectangles) and functional software modules 620 (denoted by the squared rectangles).

As an example, the data records 610 may include the following:
Manufacturers. Records might include manufacturer name and contact information, factory(ies) information, bank account information, and which products they are producing.
Products. These records include information about products: manufacturer, description, images, ratings, price, and availability.
Orders. These are order and delivery records: product, quantity, customer, order date, payment date, delivery date, and special instructions.
Showrooms. Data might include showroom operator name and contact information, bank account information, showroom location, commissions schedule, and identification of the showroom's online region.
Customers. This is information about customers: name and contact information, shipping address, and account information.
Accounts. This is ABC's internal accounting system. It may track accounts receivable and accounts payable, as well as other accounts information, for the various manufacturers, customers and showroom operators.
Inventory. This tracks the movement of physical products: how many products are stored at which locations.

The functional software modules 620 perform different tasks:
ABC web site (customer interface). This is the customer-facing online presence. It describes the products for sale. It also identifies the various showrooms and allows a customer to locate the nearest showroom. The showrooms may have their own web sites (preferably linked to the ABC main site), or they may have sections within the ABC site. There may also be pages for customer service, inquiries, suggestions, and requests for returns, support or service. Customers may place orders via the web site and preferably may also make payment via the web site.
Order module. The order module processes and tracks orders. When a customer places an order at the ABC web site, the order module processes this order and makes corresponding changes to the affected data records. For example, it may create a new order record in the Orders database, and notify the manufacturer that an order for its products has been placed. It will also create an accounts payable record corresponding to the order in the Accounts database.
Payment module. The payment module tracks payments. When a customer makes payment, the payment module makes corresponding changes in the Accounts database. It may also calculate the division of the customer payment into commission for ABC, commission for the showroom and amount paid to the manufacturer.
Supply chain module. This module tracks delivery of products and may also provide management of the overall supply chain. For example, it may predict expected demand for products based on current and forecasted orders, and issue notifications if the current inventory levels are expected to be insufficient to meet demand in a timely manner.
Manufacturer interface. This is the interface that manufacturers use to access relevant information in the system. For example, they may check which of their products are being offered, volume of products ordered by customers, supply chain for their products, settlement of accounts, account balance, wire transfers, etc.
Showroom interface. This is the interface for showroom operators. For example, they may check their local inventory of display products, order additional display products, check order activity for their online region, their account information, etc.
Accounts module. This module implements access to accounts information.

In alternate embodiments, the software system 600 is implemented in computer hardware, firmware, software, and/or combinations thereof. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits) and other forms of hardware.

The term “module” is not meant to be limited to a specific physical form. Depending on the specific application, modules can be implemented as hardware, firmware, software, and/or combinations of these. Furthermore, different modules can share common components or even be implemented by the same components. There may or may not be a clear boundary between different modules. Depending on the form of the modules, the “coupling” between modules may also take different forms. Dedicated circuitry can be coupled to each other by hardwiring or by accessing a common register or memory location, for example. Software “coupling” can occur by any number of ways to pass information between software components (or between software and hardware, if that is the case). The term “coupling” is meant to include all of these and is not meant to be limited to a hardwired permanent connection between two components. In addition, there may be intervening elements. For example, when two elements are described as being coupled to each other, this does not imply that the elements are directly coupled to each other nor does it preclude the use of other elements between the two.

Although the detailed description contains many specifics, these should not be construed as limiting the scope of the invention but merely as illustrating different examples and aspects of the invention. It should be appreciated that the scope of the invention includes other embodiments not discussed in detail above. For example, in the above example, the factories were in China and the customers were in the U.S. This is not required. The approach described above could be used entirely domestically, where all manufacturers and customers are in the same country or region, although there are some advantages to using the approach for cross-border transactions. Trans-Pacific transactions are not limited to China and the U.S. and could involve other countries, or could involve U.S. manufacturers and Chinese customers.

As another example, not all aspects described above must always be implemented and various aspects may be used independently. For example, ABC is not required to use representative physical showrooms for advertising. ABC could advertise in other ways and not use representative physical showrooms at all. Conversely, representative physical showrooms could be implemented for purposes other than described above. A conventional distributor that purchases products from manufacturers might authorize representative physical showrooms to advertise these products, even though the conventional distributor's business model is different from the ABC business model described above.

Various other modifications, changes and variations which will be apparent to those skilled in the art may be made in the arrangement, operation and details of the method and apparatus of the present invention disclosed herein without departing from the spirit and scope of the invention as defined in the appended claims. Therefore, the scope of the invention should be determined by the appended claims and their legal equivalents.

In the claims, reference to an element in the singular is not intended to mean “one and only one” unless explicitly stated, but rather is meant to mean “one or more.” In addition, it is not necessary for a device or method to address every problem that is solvable by different embodiments of the invention in order to be encompassed by the claims.

What is claimed is:

1. A method for commercializing manufacturer-direct products, the method comprising an intermediary company performing the following:
qualifying and obtaining commitments from multiple manufacturers to allow the intermediary company to advertise products from the manufacturers under the intermediary company's brand name;
advertising such products under the intermediary company's brand name;
receiving orders and payments from customers for such products;
retaining a first commission on the payments; and
transmitting a manufacturer's invoice amount of the payments to the manufacturers and effecting delivery of the ordered products from the manufacturers to the customers.

2. The method of claim 1 wherein customers may place orders for products through the intermediary company's online presence.

3. The method of claim 2 wherein the manufacturers can access online the volume of their products ordered by customers.

4. The method of claim 1 wherein customers may place orders for products through the intermediary company's online presence; a majority of the received orders (in terms of revenue) is placed through the intermediary company's online presence; and advertising the products includes advertising the products through representative physical showrooms that are authorized by the intermediary company but that are operated by entities other than the intermediary company.

5. The method of claim 4 wherein the intermediary company controls the look and presentation of the representative physical showrooms.

6. The method of claim 4 wherein the representative physical showrooms carry sample products for display purposes.

7. The method of claim 6 wherein at least some of the representative physical showrooms are primarily for display of products and do not make retail sales of products to customers.

8. The method of claim 4 further comprising the intermediary company transmitting a second commission on the payments to the operators of the representative physical showrooms, wherein the operator is entitled to receive second commissions for those orders placed from an online region that corresponds to a physical location of the operator's representative physical showroom.

9. The method of claim 4 wherein the second commission is larger if the order is placed online from the representative physical showroom, rather than from within the online region but not from the representative physical showroom.

10. The method of claim 4 wherein delivery of products comprises shipping products to representative physical showrooms for pick up by customers.

11. The method of claim 4 wherein representative physical showrooms accept returns of products from customers.

12. The method of claim 4 wherein representative physical showrooms provide service and/or support of products to customers.

13. The method of claim 1 further comprising the intermediary company selecting the products.

14. The method of claim 1 further comprising the intermediary company providing specifications for at least some of the products.

15. The method of claim 1 further comprising the intermediary company reviewing and qualifying the manufacturer's factory.

16. The method of claim 1 wherein the intermediary company has some control over the quality of the products.

17. The method of claim 1 wherein the intermediary company is responsible for accepting returns, providing service and/or providing support to customers.

18. The method of claim 1 wherein the manufacturer determines a base price for a product, and the first commission is based on the base price.

19. The method of claim 1 wherein the manufacturer determines a base price for a product, and the price to the customer does not include markup for any additional intermediaries between the manufacturer and the intermediary company.

20. The method of claim 1 wherein for a majority of the received orders (in terms of revenue), the manufacturer's factory is located in one country and the customer's receiving point is located in a different country.

21. The method of claim 20 wherein for a majority of the received orders (in terms of revenue), distribution of the ordered products from the manufacturers to the customers includes shipping across the Pacific Ocean.

22. The method of claim 20 wherein effecting distribution of the ordered products comprises the intermediary company aggregating products from different manufacturers into containers for shipment across the Pacific Ocean.

23. The method of claim 20 wherein for a majority of the received orders (in terms of revenue), the manufacturer's factory is located in China and the customer's receiving point is located in U.S.

24. The method of claim 23 wherein the customers make payment to a U.S. bank account of the intermediary company, and the intermediary company transmits the manufacturer's invoice amount of the payments to a U.S. bank account of the manufacturer.

25. The method of claim 23 wherein effecting distribution of the ordered products comprises a supply chain that includes a distribution center in the U.S. operated by the intermediary company.

26. The method of claim 1 wherein the intermediary company sells products from at least 100 different manufacturers.

27. A computer program product for commercializing manufacturer-direct products, the computer program product stored on a tangible non-transitory computer-readable medium and including instructions that, when loaded into memory, cause a computer system to perform the following:
advertising products under an intermediary company's brand name, wherein the intermediary company has qualified and obtained commitments from multiple manufacturers to allow the intermediary company to advertise products from the manufacturers under the intermediary company's brand name;
receiving orders from customers for such products, the orders being direct between the customer and the manufacturer;
retaining a first commission on the payments; and
transmitting a manufacturer's invoice amount of the payments to the manufacturers and effecting delivery of the ordered products from the manufacturers to the customers.
